(19) United States
(12) Patent Application Publication
(10) Pub. No.: US 2004/0023189 A1
(43) Pub. Date: Feb. 5, 2004

(54) System and method for displaying a nutritional program

(76) Inventor: Kevin John Bateman, Lower Hutt (NZ)

Correspondence Address: D. Douglas Price, Steptoe & Johnson LLP, 1330 Connecticut Avenue, N.W., Washington, DC, 20036, US

(21) Appl. No.: 10/628,512

(22) Filed: Jul. 29, 2003

(30) Foreign Application Priority Data
Jul. 30, 2002 (NZ) 520444
Feb. 24, 2003 (NZ) 524351

(51) Int. Cl. G09B 9/00; G09B 19/00

(52) U.S. Cl. 434/127; 434/365

(57) ABSTRACT

A dietary planning method and apparatus. Macronutrients in the form of a carbohydrate, or a protein or a fat are individually identified as a colour on a mini-block, which can be a physical entity or a computer generated shape. Each mini-block also illustrates an item of food which corresponds to the macronutrient. The mini-blocks can be assembled into a block or blocks to represent a meal. Each mini-block can also display a symbol to identify whether the food signified by the mini-block is favourable, not favourable or a fair choice.

### BACKGROUND TO THE INVENTION

There is a need to eat a balance of macronutrients, that is protein, carbohydrate and fat to secure a satisfactory diet and this invention relates to a manner of visually displaying a method of achieving that balance. This balance can be obtained by choosing food having macronutrients in the ratio of for instance 7 grams of protein, 9 grams of carbohydrate and 3 grams of fat. The difficulty with choosing the food is that it can be excessively complicated for the person to actually decide whether the food that is to be eaten will fall within the desired ratios.

It is known to use blocks which can be coloured or shaped to represent weights and composition of the macronutrients of food and to use those blocks to construct a visual representation of the nutritional qualities available in the food that the person desires to eat. However known systems do not go far enough to enable a person to visually display a range of macronutrients that will constitute a meal having the desired nutritional and dietary qualities.

### PRIOR ART

U.S. Pat. No. 6,296,488 discloses a diet method in which a plate is formed into a number of compartments each of which would enclose a representation of a specific quantity of food. A number of food cards are provided are provided which display lists of varieties of foods with the foods being listed in specific sections to correspond to the compartments on the plate. The meal cards fit the shape of the compartments so the user can see the food items which may be used to fill the compartments.

U.S. Pat. No. 5,683,251 discloses a board which is divided into regions. A number of tokens are provided each of which represent a food or a beverage item selected from a specific food group and which are adapted to stick to the board. The tokens enable a person to track consumption of foods or beverages from the various food and beverage groups by adjusting the number of types of tokens and displaying them in the appropriate regions on the board.

### OBJECT OF THE INVENTION

It is therefore an object of this invention to provide a display means which can be utilised to enable a user to readily calculate a nutritional program by identifying the macro nutritional components of food and assembling those components to form a basis for a meal.

It is also an object of the invention to provide a system by which the user can simply and easily arrange display selected macro nutritional components of foods into a geometrical form.

It is a still further object of this invention to provide a dietary planning method which can be visually displayed.

### SUMMARY OF THE INVENTION

In the following description and claims the term mini-block and block is used. It is to be understood a mini-block and a block can be a physical entity or it can be an electronically simulated shape generated by a computer program.

In one preferred form then invention comprises a dietary planning method and apparatus including

a plurality of mini-blocks each identifying a nutrient of a food

wherein each mini-block has means to identify a particular food which includes the nutrient signified by the mini-block and

wherein each mini-block also represents a specific parameter of the food containing the nutrient.

and further wherein a plurality of mini-blocks can be combined to form a block to visually display a balanced program of the selected macronutrients.

Preferably the specific parameter on each mini-block is the number, size, composition or volume of the food.

Preferably each mini-block is coloured to represent carbohydrate, protein or fat nutrients.

Preferably the colours on the mini-blocks are green for carbohydrate, brown for protein and yellow for fat nutrients.

Preferably the mini-blocks include identification means to indicate whether the food signified by the mini-block is favourable, not favourable, or a fair choice.

Preferably each mini block comprises a physical entity.

Preferably each mini-block includes a substance which can be magnetized.

Preferably the apparatus includes a template on which the mini-blocks can be stored and/or displayed.

Preferably each mini block is an electronically simulated unit.

In another aspect the invention is a dietary planning method and apparatus including

a template having at least one row of spaces, each space in a row being identified to signify an amount of carbohydrate nutrient or a protein nutrient or a fat nutrient of a food, and

a plurality of mini-blocks with each mini-block being identified to signify a carbohydrate nutrient or a protein nutrient or a fat nutrient of a food

wherein each mini-block has means to identify a particular food which includes the nutrient signified by the mini-block and

wherein each mini-block also represents a specific parameter of the food containing the nutrient

and further wherein the mini-blocks can be located on the template and combined to form a block to visually display the selected food macronutrients.

Preferably the specific parameter is the number, size, content or volume of the food.

Preferably the mini-blocks and the spaces on the template are coloured to represent the specific nutrient.

Preferably the template includes an area for storing the mini-blocks prior to their being moved onto the spaces on the template.

Preferably the area for storing mini-blocks comprises a plurality of spaces which are identified to represent foods and/or macronutrients for foods.

Preferably the colour on each mini-block is selected to represent a carbohydrate, or a protein or a fat nutrient.

Preferably the colour on each mini-block is green to signify carbohydrate, brown to signify protein and yellow to signify fat nutrients.

Preferably at least one space on the template is coloured to signify a carbohydrate, or a protein of a fat nutrient.

Preferably at least one mini-block includes identification means to indicate whether the food signified by the mini-block is favourable, not favourable, or a fair choice.

Preferably the template is magnetisable and each mini-block includes a material capable of being magnetised.

Preferably the template and the mini-blocks are electronically simulated shapes generated by a computer program.

### BRIEF DESCRIPTION OF THE DRAWINGS

A preferred form of the invention will now be described with the aid of the accompanying drawings wherein:

FIGS. 1 and 2 are illustrations of a series of full sized mini-blocks depicting different forms of identifications.

FIG. 3 is an illustration of a half sized mini-block.

FIG. 4 is an illustration of a combination of a full sized and a half sized miniblock.

FIG. 5 is an illustration of a combination of two full sized mini-blocks.

FIG. 6 is an illustration of a block formed by the combination of mini-blocks.

FIG. 7 is an illustration of a typical form of a template.

FIGS. 8a, 8b and 8c are examples of templates signifying a one block meal, a two block meal and a three block meal respectively.

FIG. 9 is an illustration of a partially constructed three block meal on a template.

### DESCRIPTION OF A PREFERRED EMBODIMENT

Preferred forms of the invention will now be described with the aid of the accompanying drawings. In all of the Figures of the drawings, the horizontal hatching represents a specific colour such as green, the diagonal hatching represent another specific colour such as brown and the vertical hatching represents yet another specific colour such as yellow. It will however be understood that the colours selected are essentially arbitrary and the colours referred to herein are given as an example only.

In a highly preferred form the colour green may represent carbohydrate nutrients, the colour brown may represent protein nutrients and the colour yellow may represent fat nutrients. In a highly preferred form of the invention each mini-block may consist of a rectangular piece which may be a relatively thin structure and which in one form as is hereinafter further described, can be suitably magnetized so each mini-block can magnetically adhere to a surface.

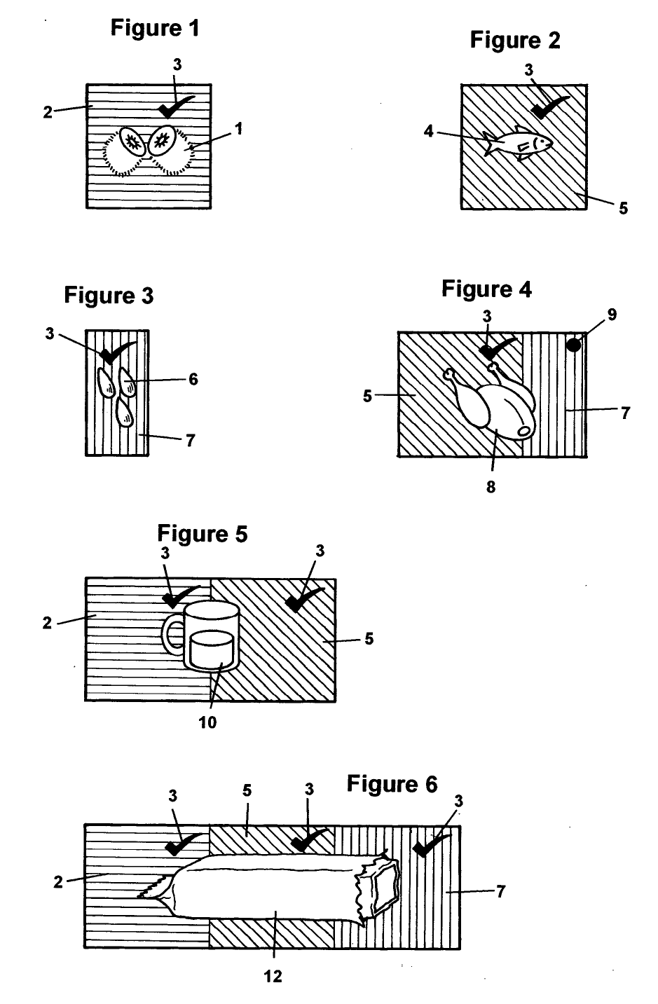

Each mini-block is preferably of a specific geometrical or non geometrical shape and if the mini-blocks are in the shapes of rectangles as illustrated in the drawings, the mini-blocks can be of two sizes, such as a full size mini-block illustrated in FIGS. 1 and 2 which is in the form of a square and a half size mini-block such as illustrated in FIG. 3 which is in the form of a rectangle. Mini-blocks may be positioned contiguously on any surface such as illustrated in FIGS. 4 and 5, to represent a sum of different or combinations of nutrients to form a full block or parts of a block as will be further described below.

In accordance with a highly preferred method of the present invention the colour green represents the carbohydrate content of a food with a nutrient weight of nine grams. The colour brown represents the protein content of a food with a nutrient weight of seven grams and the colour yellow represents a fat content of a food with a nutrient weight of one and a half grams. As it will be realised, the weights represented by the coloured mini-blocks and the physical sizes of the mini-blocks can vary according to the specific requirements.

To enable ready identification, the mini-blocks may also include a representation of different foods. For instance the image on the mini-block illustrated in FIG. 1 represents a kiwi fruit 1 and because kiwi fruit contains carbohydrate, the background 2 is green. It will be noted the mini-block illustrated in FIG. 1 includes a tick 3 which can be green, see the description below, which indicates that the food is favourable.

In addition, preferably each mini-block displays a specific quantity of the amount of each food. In one highly preferred form, the amounts will equate to 7 grams of protein, 9 grams of carbohydrate or 1.5 grams of fat. As an example a mini-block could have a picture of a zucchini and display a green tick and also display the legend ‘3 cups r’ or ‘2 cups c’ where ‘r’ represents raw and ‘c’ represents cooked.

Ticks are preferably used to signify ratings to indicate a food is favourable and the ticks may be coloured appropriately. For instance a green tick would signify the most favourable, an orange tick could signify the foods is favourable but not as favourable as a green tick. Similarly an orange cross (X) could signify unfavourable and a red cross (X) could signify very unfavourable foods. Preferably but not necessarily a single overall rating can be applied to a block. It will be understood the ticks and crosses referred to above can be replaced by other symbols as desired.

The image on the mini-block illustrated in FIG. 2 represents a fish 4 which contains protein and so it is represented on a brown background 5 and because fish is favourable for the diet, the mini-block also includes a tick 3 and the amount of fish that contains 7 grams or a unit of protein, that is 40 grams.

The image on the mini-block illustrated in FIG. 3 represents almonds 6 which contain fat and so is represented on a yellow background 7 and because it is a favourable food the mini-block includes a tick 3. It will be noted the mini-block illustrated in FIG. 3 is approximately half the width of the mini-block illustrated in FIGS. 1 and 2. Items that are displayed on half sized mini-blocks will usually be fat nutrients which are normally depicted as a half mini-block. In addition, some of the carbohydrate miniblocks are split in half in order that half quantities of these mini-blocks can be selected.

FIG. 4 is an illustration of a food item containing a full unit of protein and a half unit of fat. It would require the addition of another half mini-block of fat plus a full mini-block of carbohydrate to complete a balanced block of protein, carbohydrate and fat. The example illustrated in FIG. 4 is a combination of mini-blocks which represent thirty grams of lean chicken 8. Since chicken contains protein and fat, the representation of a chicken spans a mini-block of brown background 5 and a half mini-block of yellow background 7 to represent fat.

FIG. 5 illustrates a food item containing the combination of two full sized mini-blocks, that is carbohydrate and protein. Consequently to complete a balanced block of protein, carbohydrate and fat would require the addition of two half mini-blocks of fat. The Figure depicts a half cup of yoghurt which contains a protein mini-block which is represented on a brown background 2 and a carbohydrate mini-block on a green background 2. Since yoghurt is regarded as favourable, the mini-block includes a tick 3.

FIG. 6 is an illustration of a ‘Zone Bar™ 12 which has a green background 2, a brown background 5 and a yellow background 7. The food item illustrated in this Figure contains a complete balanced block of full units of carbohydrate, protein and fat.

The above illustrate sample of the many combinations of mini-blocks that can be prepared to signify the various foods that may be eaten. In a highly preferred form, each mini-block will either show a protein content in seven gram amounts, a carbohydrate content in nine gram amounts or a fat content in one and a half gram amounts or a combination of these nutrients.

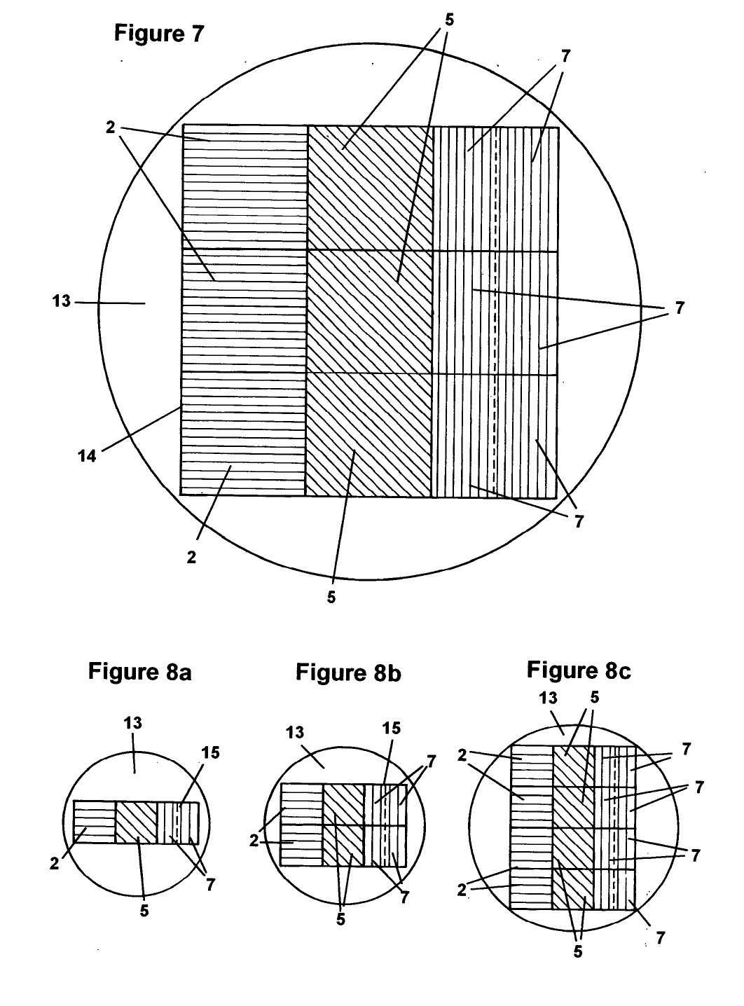

FIG. 7 is an illustration of a template that could be used in conjunction with the mini-blocks, the coloured squares corresponding with the background colours of the mini-blocks.

The template illustrated in FIG. 7 would represent a typical three block meal selected according to the requirements of the system when the squares have been completely occupied by selected food mini-blocks.

FIG. 8 represents templates for a typical one block snack.

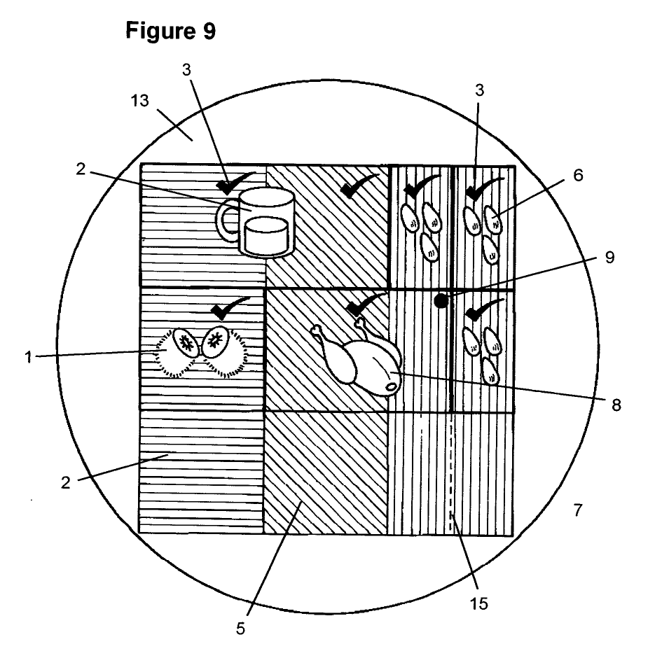

FIG. 9 represents a partially completed three block meal which in the form illustrated includes of a half cup of yoghurt 2, nine almonds 6, thirty grams of lean chicken 8 and a kiwi fruit 1. In this example a template is illustrated and is provided with coloured spaces for the mini-blocks to be positioned on the spaces to complete the construction of a three block meal.

If a template is used it will also preferably include further spaces for storing mini-blocks prior to the mini-blocks being assembled onto the template. Such spaces can be coloured or otherwise identified to assist in the placement of the mini-blocks so they can be readily located when required.

It is to be understood that the mini-blocks, while preferably are magnetic or include means that will allow the mini-blocks to temporarily adhere to a surface, that is not essential. It is desirable, but not necessary that some means are provided to enable the mini-blocks to remain located in the desired pattern on a surface and that means can take many forms. For instance one means would be to utilize pegs which can protrude from the mini-blocks and which can be inserted into appropriately located holes in a surface. In another form the mini-blocks can be provided with holes so pegs can be inserted through the holes and into selected holes formed in a surface. It is also contemplated that the mini-blocks are merely formed so they can be rested on a surface without any means being provided to maintain the location of the mini-blocks on the surface. The mini-blocks can also include various forms of media which will enable the mini-blocks to temporarily adhere to a surface can be utilised. One such media is that known as “VELCRO”™

To utilise the system, a substantially flat surface is selected. If the mini-blocks are magnetized, then a convenient surface could be, for instance, a thin metal box with the template FIGS. 7 and 8 on the front. The interior of the box would provide storage for the magnetic mini-blocks. The wall or door of a refrigerator or some other surface composed of a metal that will attract a magnet or other item could also be used. The surface can, in one form, be delineated such as by applying a template to the surface which does not interfere with the ability of a magnet to be attracted to the surface. One form of template could for instance be what is known as a ‘fridge magnet’ or any other suitable magnetic or non magnetic material. It will however be understood that it is not necessary to have the surface delineated, since with sufficient familiarity of the system, the user will be able to assemble the mini-blocks in the desired order without the necessity of using a template or other guide.

While in the above disclosure a method of planning a dietary program is described using a plurality of mini-blocks signifying either carbohydrate, protein or fat macronutrients of combinations of those macronutrient which can be physically located on a surface, it is to be understood the invention also contemplates replacing the mini-blocks with electronically simulated mini-blocks which can be located on an electronically simulated background. Such an electronic system can be generated by appropriate electronic programming in a computer with appropriate hardware to generate and display the dietary program. It is envisaged that a program using the system would be designed not only for desk top type computers, but also for computers commonly known as lap tops and hand held devices.

The application of the block system as described above enables a person to see pictures of common foods and the nutrient provided by such foods and then by arranging the mini-blocks on a surface, can build up an illustration of a meal having the desired nutritional and dietary qualities. Consequently the person is able to readily visualize how the diet plan is working because the user is able to select food items from the three groups and arrange them on the surface to illustrate the composition of the meal.

Having described preferred methods of putting the invention into effect, it will be apparent to those skilled in the art to which this invention relates, that modifications and amendments to various features and items can be effected and yet still come within the general concept of the invention. It is to be understood that all such modifications and amendments are intended to be included within the scope of the present invention.

1. A dietary planning method and apparatus including
a plurality of mini-blocks each being identifying a nutrient of a food
wherein each mini-block has means to identify a particular food which includes the nutrient signified by the mini-block and
wherein each mini-block also represents a specific parameter of the food containing the nutrient.
and further wherein a plurality of mini-blocks can be combined to form a block to visually display a balanced program of the selected macronutrients.

2. The dietary planning method and apparatus as claimed in claim 1, wherein the specific parameter on each mini-block is the number, size, composition or volume of the food.

3. The dietary planning method and apparatus as claimed in claim 1, wherein each mini-block is coloured to represent carbohydrate, protein or fat nutrients.

4. The dietary planning method and apparatus as claimed in claim 3, wherein the colours on the mini-blocks are green for carbohydrate, brown for protein and yellow for fat nutrients.

5. The dietary planning method and apparatus as claimed in claim 1, wherein the mini-blocks include identification means to indicate whether the food signified by the mini-block is favourable, not favourable, or a fair choice.

6. The dietary planning method and apparatus as claimed in claim 1, wherein each mini block comprises a physical entity.

7. The dietary planning method and apparatus as claimed in claim 6, wherein each mini-block includes a substance which can be magnetized.

8. The dietary planning method and apparatus as claimed in claim 1, including a template on which the mini-blocks can be stored and/or displayed.

9. The dietary planning method and apparatus as claimed in claim 1, wherein each mini block is an electronically simulated unit.

10. In another aspect the invention is a dietary planning method and apparatus including
a template having at least one row of spaces, each space in a row being identified to signify an amount of carbohydrate nutrient or a protein nutrient or a fat nutrient of a food, and
a plurality of mini-blocks with each mini-block being identified to signify a carbohydrate nutrient or a protein nutrient or a fat nutrient of a food wherein each mini-block has means to identify a particular food which includes the nutrient signified by the mini-block and
wherein each mini-block also represents a specific parameter of the food containing the nutrient.
and further wherein the mini-blocks can be located on the template and combined to form a block to visually display the selected food macronutrients.

11. The dietary planning method and apparatus as claimed in claim 10, wherein the specific parameter is the number, size, content or volume of the food.

12. The dietary planning method and apparatus as claimed in claim 10, wherein the mini-blocks and the spaces on the template are coloured to represent the specific nutrient.

13. The dietary planning method and apparatus as claimed in claim 10, wherein the template includes an area for storing the mini-blocks prior to their being moved onto the spaces on the template.

14. The dietary planning method and apparatus as claimed in claim 10, wherein the area for storing mini-blocks comprises a plurality of spaces which are identified to represent foods and/or macronutrients for foods.

15. The dietary planning method and apparatus as claimed in claim 12, wherein the colour on each mini-block is selected to represent a carbohydrate, or a protein or a fat nutrient.

16. The dietary planning method and apparatus as claimed in claim 15, wherein the colour on each mini-block is green to signify carbohydrate, brown to signify protein and yellow to signify fat nutrients.

17. The dietary planning method and apparatus as claimed in claim 12, wherein at least one space on the template is coloured to signify a carbohydrate, or a protein of a fat nutrient.

18. The dietary planning method and apparatus as claimed in claim 10, wherein at least one mini-block includes identification means to indicate whether the food signified by the mini-block is favourable, not favourable, or a fair choice.

19. The dietary planning method and apparatus as claimed in claim 10, wherein the template is magnetisable and each mini-block includes a material capable of being magnetised.

20. The dietary planning method and apparatus as claimed in claim 10, wherein the template and the mini-blocks are electronically simulated shaped generated by a computer program.
